(19) United States
(12) Patent Application Publication
(10) Pub. No.: US 2014/0007087 A1
(43) Pub. Date: Jan. 2, 2014

(54) VIRTUAL TRUSTED PLATFORM MODULE

(71) Applicants: Mark Scott-Nash, Boulder, CO (US); Alberto Munoz, Los Altos, CA (US); Asher Altman, Bedford, MA (US)

(72) Inventors: Mark Scott-Nash, Boulder, CO (US); Alberto Munoz, Los Altos, CA (US); Asher Altman, Bedford, MA (US)

(21) Appl. No.: 13/537,347

(22) Filed: Jun. 29, 2012

(51) Int. Cl. G06F 9/455

(52) U.S. Cl. 718/1

(57) ABSTRACT

A technique includes providing a virtual trusted platform module for a virtual machine and containing the virtual trusted platform module within a secure enclave of a physical platform.

### BACKGROUND

A typical computer may contain a trusted platform module (TPM), which typically is an integrated circuit that includes a cryptographic processor and a secure memory. The TPM typically forms the root of trust for the computer in conjunction with the computer's basic input/output system (BIOS). In this regard, the TPM may be regarded as a root of trust for reporting and a root of trust for storage, in that the TPM securely stores various cryptographic keys and measurements of the computer's software and hardware configurations (as measured by the BIOS).

### BRIEF DESCRIPTION OF THE DRAWINGS

FIG. 1 is a schematic diagram of a processor-based machine according to an example implementation.

FIG. 2 is a schematic diagram of a virtual trusted platform module architecture according to an example implementation.

FIG. 3 is an illustration of the relationship of the virtual trusted platform module, a virtual trusted platform module supervisor and secure enclaves according to an example implementation.

FIG. 4 is a flow diagram depicting a technique to provide a virtual trusted platform module according to an example implementation.

FIG. 5 is an illustration of different states of the virtual trusted platform module according to an example implementation.

### DETAILED DESCRIPTION

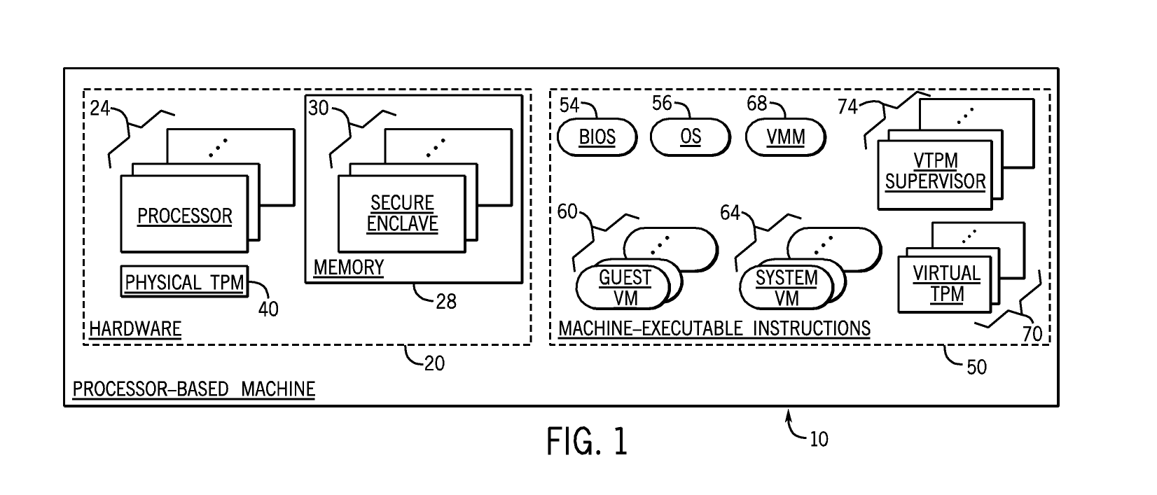

Referring to FIG. 1, a hardware platform, such as processor-based machine 10, may include a physical trusted platform module (TPM) 40 (herein called the “physical TPM 40”). In general, the physical TPM 40 is a hardware device (an integrated circuit, which may be contained in a semiconductor package, or “chip,” as an example) that includes a cryptographic processor and a secure memory. The physical TPM 40 forms the roots of trust for reporting and storage for the processor-based machine 10. In this regard, the secure memory of the physical TPM 40 stores cryptographic keys as well as measurements for the processor-based machine 10, which are acquired and written to the physical TPM 40 by a basic input/output system (BIOS) 54 of the machine 10, in accordance with some implementations.

As non-limiting examples, the processor-based machine 10 may be a desktop computer; a portable computer; a tablet computer; a server; a wide area network (WAN) server; an Internet-based server; a cloud server; a client; a thin client; a cellular telephone; a smartphone; or in general, any machine that includes at least one processor 24 (a microprocessor, a microcontroller, a processing core of such a microprocessor or microcontroller, and so forth). Regardless of its particular form, the processor-based machine 10 is a physical machine that is formed from a physical platform, or physical hardware 20, and machine executable instructions 50, or software, in accordance with example implementations.

In addition to the physical TPM 40 and the processor(s) 24, the processor-based machine 10 may contain various other physical hardware components, such as, for example, components that form a memory 28 of the machine 10. In general, the memory 28 may be a system memory, a cache memory, a microprocessor-based memory, a memory internal to a processor 24, a memory external to a processor 24, a combination of such memories, and so forth, depending on the particular implementation. Moreover, the memory 28 is a non-transitory memory and may be formed from such memory devices as semiconductor devices, optical storage devices, phase change memory devices, magnetic storage devices, and so forth. One or more (even all) of the hardware components of the processor-based machine 10 may be part of the same integrated circuit or may be parts of intercoupled integrated circuits, depending on the particular implementation.

As further disclosed herein, the processor-based machine 10 may have one or more virtual components, in accordance with example implementations. In this manner, the processor-based machine 10 may include a hypervisor, or virtual machine monitor (VMM) 68, that virtualizes the machine's hardware 20 to provide virtual operating platforms to allow guest virtual machines (herein called “guest VMs 60”) to execute, or run, concurrently on the machine 10. Thus, in general, each guest VM 60 is unaware of the existence of the other guest VM(s) 60, and each guest VM 60 perceives its virtual operating platform as a physical platform.

A given guest VM 60, during its course of operation, may receive a request from a verifier, for attestation of the guest VM's virtual platform. More specifically, as further described herein, the verifier requests a virtualized TPM (called a “virtual TPM” herein) to attest for the guest VM 60. The verifier may be an entity (an application or an Internet server, as examples) that is external to the processor-based machine 10 and may or may not be a trusted third party. For purposes of providing sufficient proof to the verifier, the guest VM 60 may rely on a virtualized version of the physical TPM 40 to provide the information to attest to the VM's authenticity.

One way to virtualize the physical TPM 40 is for the physical TPM 40 to securely store the secrets (keys, measurements, certificates and so forth) for the guest VMs 60, so that the physical TPM 40 may be used to attest to a given guest VM's authenticity. However, reliance on such a scheme may be relatively challenging, as the physical TPM 40 may be relatively incapable of serving more than one platform and providing the appropriate security to partition the stored secured data among the guest VMs 60. Moreover, for such an approach, a high degree of trust is afforded to the VMM 68, as the VMM 68 has access to the secrets of all of the guest VMs 60. Lastly, such an approach may be challenging for migration purposes due to the relatively difficult and resource consuming challenges of migrating secrets between physical TPMs that reside on different physical platforms when guest VMs are migrated between those platforms.

In accordance with the systems and techniques that are disclosed herein, the processor-based machine 10 virtualizes the physical TPM 40 for its guest VMs 60 using one or multiple virtual trusted platform modules (TPMs) 70 (herein called “virtual TPMs 70”). The virtual TPM 70, in turn, may be used to provide information to a requesting verifier to attest to the authenticity of an associated guest VM 60.

The virtual TPMs 70 may be viewed as virtualized versions of the physical TPM 40 for the guest VMs 60: each virtual TPM 70 serves as the roots of trust for measurement and storage for an associated guest VM 60. In accordance with example implementations that are disclosed herein, the processor-based machine 10 bind a given virtual TPM 70 to a given guest VM 60. After a given virtual TPM 70 is bound to a given guest VM 60, the processor-based machine 10 does not re-assign the given virtual TPM 70 to another guest VM 60, regardless of whether the originally-assigned guest VM 60 is migrated or retired.

In accordance with the systems and techniques that are disclosed herein, the virtual TPM 70 is contained within a secure enclave 30 of the processor-based machine 10. The secure enclave 30 protects the secrets of the virtual TPM 70 without involving the direct use of the physical TPM 40; and the secure enclave 30 protects the secrets of the virtual TPM 70 from the firmware, the VMM 68 and other processes that are running, or executing, on the processor-based machine 10.

In general, a secure enclave 30 is a set of memory locations that provides a safe place for an application to execute program instructions and store data inside the enclave 30 in the context of an operating system (OS) process. Thus, an application that executes in this environment is called an “enclave.” Enclaves are executed from an enclave page cache, and the enclave pages are loaded into the enclave page cache by an operating system. Whenever a page of a secure enclave 30 is removed from the enclave page cache, cryptographic protections are used to protect the confidentiality of the page and to detect tampering when the page is loaded back into the enclave page cache. Inside the enclave page cache, enclave data is protected using access control mechanisms, which are provided by the processor(s) 24, and the pages of the page cache are also encrypted.

In general, the enclave page cache is where enclave code is temporarily stored in its encrypted state. The enclave code is fetched from the enclave page cache, decrypted and placed in the processor cache where the code is retrieved and executed in the same manner as non-enclave code, and where enclave data is accessed by the processor 24. Thus, in general, the hardware of the processor-based machine 10 provides a mechanism for protecting certain memory locations, and as described herein, this mechanism is used to protect the virtual TPMs 70. In general, the enclave page cache may be located within the physical address space of the processor-based machine 10, and the enclave page cache may be accessed solely through the use of secure enclave instructions, which are a subset of instructions executed by the processor(s) 24. It is noted that the enclave page cache may contain pages from many different secure enclaves 30 and may provide access control mechanisms to protect the integrity and confidentiality of the pages. The enclave page cache maintains a coherency protocol similar to the one used to preserve coherent physical memory accesses in the processor-based machine 10.

The enclave page cache uses an enclave page cache map, which contains the state information associated with each page in the enclave page cache. The state information indicates information such as the particular enclave 30 to which a given page belongs, the state of a loaded page, and so forth. When a page is removed from the enclave page cache, the state information is exported from the enclave page cache map as well as protected using cryptographic means. Similarly, when a given enclave page is re-loaded into the enclave page cache, the state information is verified.

It is noted that the enclave page cache may be stored in many different types of memories, depending on the particular implementation. For example, in accordance with some implementations, the enclave page cache may be stored on board static random access memory (SRAM) of a given processor 24. As another example, the enclave page cache may be stored as part of a dynamic random access memory (DRAM) that is disposed on the processor 24 or disposed separately from the processor 24. The enclave page cache may also be constructed by dynamically sequestering ways of the processor's last-level cache. For these implementations, the enclave page cache may be protected from unauthorized accesses from outside the processor package, while allowing other packages in the system to access the enclave page cache coherently yet securely.

In further implementations, the enclave page cache may be a cryptographic memory aperture, which may provide a relatively cost-effective mechanism of creating cryptographically-protected volatile storage using DRAM. In this manner, the cryptographic memory aperture uses one or more strategically-placed cryptographic units in a region outside of a processing core of the processor 24 (when the processor 24 is a central processing unit (CPU), for example) to provide varying levels of protection. The various uncore agents are modified to recognize the memory accesses going to the cryptographic memory aperture and to route these accesses to a cryptographic controller located in the uncore. The cryptographic controller, depending on the desired protection level, generates one or more memory accesses to the platform DRAM to fetch the cipher text. The fetch text is then processed by the cryptographic controller to generate the plain text to satisfy the original cryptographic memory aperture request.

In accordance with some implementations, the enclave page cache is kept as a separate container, which is managed by microcode of a processor 24. In this manner, the container is not accessible when execution is outside of the secure enclave 30. When the secure enclave 30 is entered, control is transferred to the enclave code inside the enclave page cache, which is contained in a separate container.

Any page faults or exceptions that occur while executing inside of the enclave 30 are reflected by the microcode to the responsible operating system or VMM. When the processor-based machine 10 is executing outside of any of the enclaves 30, access control to the enclave page cache may be provided by a secure enclave range register of the processor 24. In this manner, the processor-based machine 10, when running inside the microcode, provides page table level protections that prevent access to other enclave page cache entries that do not belong to the executing secure enclave 30. Thus, one option to implement the secure enclaves 30 is to implement the instructions and the protections using the microcode capability of the processor 24.

More details about example implementations of the secure enclave 30 may be found, for example, in PCT Publication No. WO 2011/078855 A1, entitled, “METHOD AND APPARATUS TO PROVIDE SECURE APPLICATION EXECUTION,” which published on Jun. 30, 2011.

As further described below, a given virtual TPM 70 is initialized using certain values that uniquely describe the virtual TPM 70 (and allows the virtual TPM 70 to present itself as a valid virtual TPM) and provide information about the trust state of the underlying physical platform. The virtual TPM 70 may be provisioned by assigning keys to an initialized virtual TPM 70, as also further described below, and thereafter, the provisional virtual TPM 70 may be assigned to one of the guest VMs 60.

In addition to the guest VMs 60, VMM 68, BIOS 54 and virtual TPMs 70, the machine executable instructions 50, or software, of the processor-based machine 10 may further include such other instructions 50, as instructions 50 that when executed, form a host operating system 56 and system VMs 64, which control the provisioning and creation of the guest VMs 60, as further described below. Moreover, as depicted in FIG. 1, the machine executable instructions 50 also include one or multiple virtual TPM supervisors 74, which, as further disclosed herein, are associated with given virtual TPMs 70 and are contained in the secure enclaves 30 to manage the life cycles of the virtual TPMs 70. In accordance with some implementations, a virtual TPM supervisor 74 is associated with a physical platform and manages all of the virtual TPMs 70 residing in that platform at a given time.

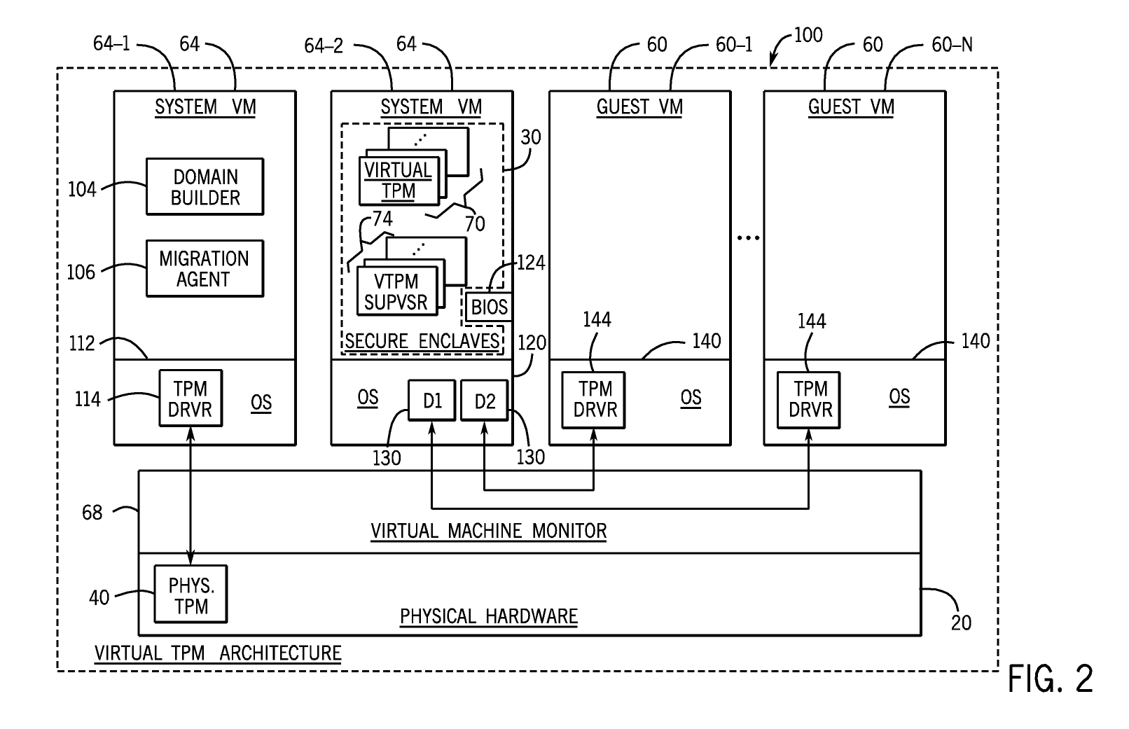

Referring to FIG. 2 in conjunction with FIG. 1, as a more specific example, in an exemplary implementation, the processor-based machine 10 may employ a virtual TPM architecture 100. The virtual TPM architecture 100 includes one or multiple system VMs 64 (system VMs 64-1 and 64-2 being depicted in FIG. 2 as examples), which, in general, provide system level control of the guest VMs 60 (guest VMs 60-1 . . . 60-N being depicted in FIG. 2 as examples). In this manner, as an example, the system VMs 64 may perform such system level control functions as managing, building and migrating the guest VMs 60. As depicted in FIG. 2, the system VM 64-1 may contain such components as a guest operating system 112, which contains a TPM driver 114 for purposes of allowing the operating system 112 to communicate with the physical TPM 40. The system VM 64-1 further includes a domain builder 104, which initializes the environments for the guest VMs 60. In this manner, the domain builder 104 may perform such functions as initializing the guest operating systems for the guest VMs 60, allocating memory for the guest VMs 60, and so forth.

The system VM 64-1 may also include a migration agent 106, which, as its name implies, manages guest VM migration. In this manner, the migration agent 106 may, for example, manage the copying of a guest VM 60 from the processor-based machine 10 to another physical platform to which the guest VM 60 is being migrated and deletes a copy of a guest VM 60 after the guest VM 60 has been migrated.

The system VM 64-2, in accordance with example implementations, contains the virtual TPMs 70 as well as the virtual TPM supervisors 74. The system VM 64-2 contains a guest operating system 120, as well as a guest basic input-output-operating system (BIOS) 124. The guest operating system 120, in turn, includes drivers 130, which permit communication between a given guest VM 60 and virtual TPM 70 pair. In this manner, each guest VM 60 contains a TPM driver 144 (part of the guest operating system 140 of the guest VM 60), which establishes communication (through the VMM 68) between the guest VM 60 and its assigned virtual TPM 70.

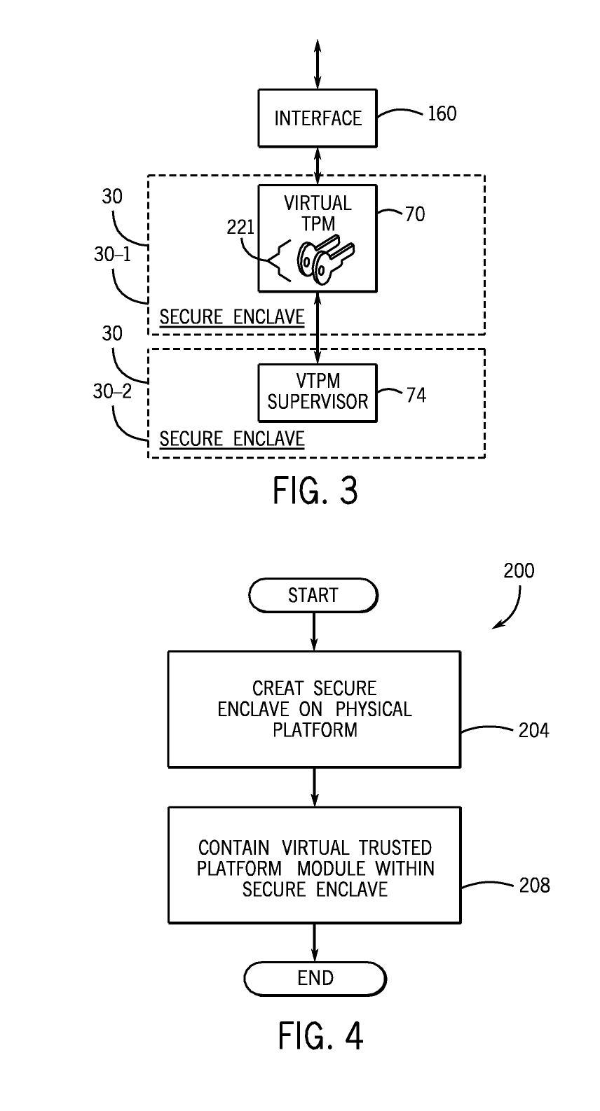

Referring to FIG. 3 in conjunction with FIG. 2, in accordance with exemplary implementations, a given virtual TPM 70 and its associated virtual TPM supervisor 74 are each contained within an associated secure enclave 30. Thus, in accordance with some implementations, each virtual TPM 70 (depicted as being contained within a secure enclave 30-1 in FIG. 3) and each virtual TPM supervisor 74 (depicted as being contained within a secure enclave 30-2 in FIG. 3) may be contained within its own associated secure enclave 30. It is noted that the depiction in FIG. 3 is simplified, in that more than one virtual TPM 70 may be associated with a given virtual TPM supervisor 74. Moreover, as shown in FIG. 3, the entities outside of its secure enclave 30 communicated with the virtual TPM 70 via a software interface 160. Thus, in accordance with some implementations, the guest VM 60 (which “owns” a given virtual TPM 70) communicates with the virtual TPM 70 via the interface 160 and a given driver 130

The virtual TPM 70 stores private keys 221, which are stored in the virtual TPM 70 when the TPM 70 is provisioned. As a more specific example, a given key 221 may be a private key of a private and public key pair, which uniquely identifies the virtual TPM 70. The keys 221 of the virtual TPM 70, in accordance with example implementations, do not venture beyond the boundaries of the associated secure enclave 30. In this manner, the virtual TPM 70 carries secure information, such as the keys 221 and certificates signed with the keys 221, between platforms and is migrated as its associated guest VM 60 is migrated.

As a more specific example, the keys 221 of a given virtual TPM 70 may include a private key of a public and private key Rivest-Shamir-Adleman (RSA) key pair, which uniquely identifies the virtual TPM 70. The virtual TPM 70 may further store a private key of a private and public attestation key pair, which is used for purposes of authenticating the virtual TPM 70 (and its associated guest VM 60) to a requesting verifier. Moreover, the virtual TPM 70 may further store various certificates, such as certificates signed by associated attestation identity keys, and so forth.

Referring to FIG. 4, thus, a technique 200 in accordance with example implementations disclosed herein includes creating (block 204) a secure enclave on a physical platform and containing (block 208) a virtual trusted platform module within the secure enclave.

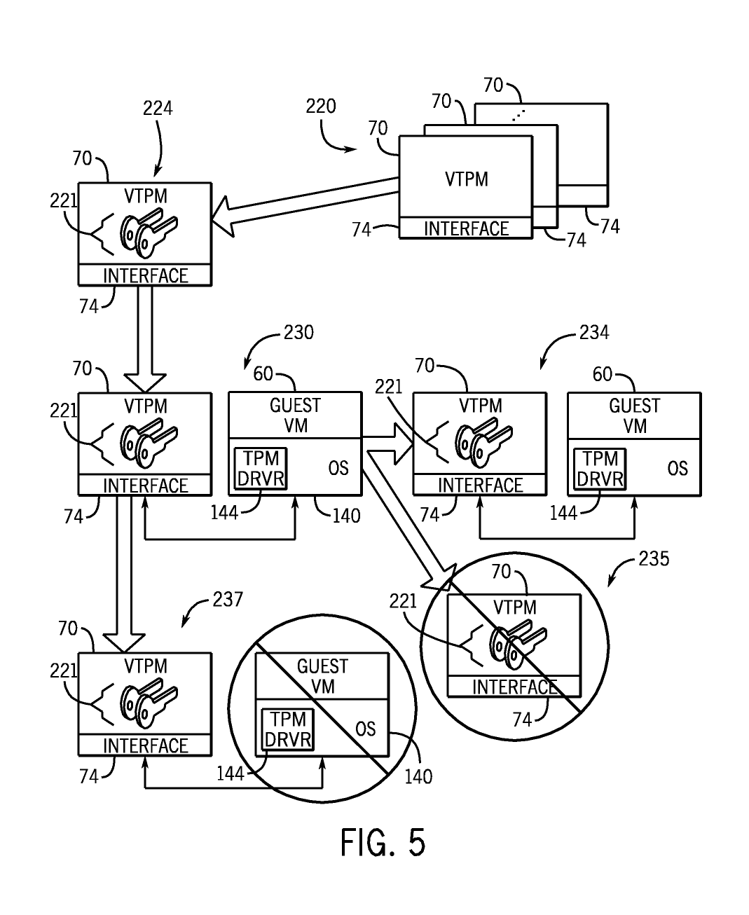

In general, the virtual TPM supervisor 74 manages the lifecycle(s) of a group of at least one virtual TPM 70. As a more specific example, FIG. 5 depicts exemplary states of a given virtual TPM 70 during its life cycle and the management of these states by the associated virtual TPM supervisor 74, in accordance with some implementations.

Initially, the virtual TPM 70 is an uninitialized state 220, a state in which the virtual TPM 70 has been created by the secure enclave 30 and is in a group, or pool, of other uninitialized virtual TPMs 70. In its uninitialized state 220, the virtual TPM 70 stores the signed root of trust measurements for the processor-based machine 10, i.e., stores the same root of trust measurements as the physical TPM 40. In this manner, the system VM 64-1 (see FIG. 2) creates the virtual TPM 70 within the secure enclave 30; and the BIOS 124 (see FIG. 2) stores the signed root of trust measurements in the virtual TPM 70 as well as a pointer to the physical TPM 40.

In response to the provisioning of a new guest VM 60, the virtual TPM supervisor 70 provisions one of the uninitialized virtual TPMs 70, which places the virtual TPM 70 in a provisioned state 224. More specifically, in accordance with example implementations, for purposes of provisioning the virtual TPM 70, an RSA key pair is assigned to the virtual TPM 70 to uniquely identify the virtual TPM 70. As an example, the virtual TPM 70 may generate its own key pair at the direction of the TPM supervisor 74. In accordance with example implementations, the keys 221 that are stored by the TPM 70 include identity keys, such as a private RSA key that is associated with a given public and private RSA key pair. The virtual TPM supervisor 74 may store other keys in the virtual TPM 70, in accordance with other implementations. Moreover, the virtual TPM 70 may create and store its own keys, such as attestation identity keys, in accordance with some implementations.

After the provisioning, the next stage in the life cycle of the virtual TPM 70 is a state 230 in which the virtual TPM supervisor 74 assigns the virtual TPM 70 to a given guest VM 60, and the virtual TPM 70 remains bound to the assigned guest VM 60 for the remainder of its life.

The virtual TPM 70 remains assigned to the guest VM 60 for the life of the guest VM 60. When the virtual TPM 70 is migrated to another platform (represented by state 234), the migration agent 106 (see FIG. 2) copies the guest VM 60 to that platform. Because the assigned virtual TPM 70 remains on the processor-based machine 10, in accordance with some implementations, the virtual TPM supervisor 74 erases, or deletes, the original virtual TPM 70, as depicted by state 235.

When the guest VM 60 goes out of scope, the virtual TPM 70 is retired, as depicted by state 237, and due to the retirement, the guest VM 60 may be deleted, as depicted in FIG. 5, by the virtual TPM supervisor 74.

In accordance with further implementations, the virtual TPM supervisor 74 may perform functions other than managing the lifecycle of one or more virtual TPMs 70, in accordance with further implementations. In this manner, in accordance with some implementations, the virtual TPM supervisor 74 may store a private key for its group of one or more associated virtual TPMs 70 for purposes of using the private key to sign attestation certificates for the virtual TPMs 70 so that the signed certificates may be used as proof of authentication for requesting verifiers. Thus, many variations are contemplated, which are within the scope of the appended claims.

The following examples pertain to further implementations.

In an example implementation, a technique includes providing a virtual trusted platform module for a virtual machine and containing the virtual trusted platform module within a secure enclave of a physical platform.

In some implementations, providing the virtual trusted module includes providing a supervisor and using the supervisor to securely manage a lifecycle of the virtual trusted platform module.

In some implementations, the technique includes containing the supervisor within a secure enclave.

In some implementations, using the supervisor to manage the lifecycle of the virtual trusted platform module includes provisioning the virtual trusted platform module, which includes assigning at least one security key to the virtual trusted platform module to identify the module.

In some implementations, the provisioning of the virtual trusted platform further includes the supervisor signing an attestation identification credential for the virtual trusted platform module.

In further implementations, using the supervisor to manage the lifecycle of the virtual trusted platform module includes using the supervisor to assign the virtual trusted platform module to the virtual machine.

In some implementations, using the supervisor to manage the lifecycle of the virtual trusted platform module includes managing a migration of the virtual trusted platform module to another physical platform.

In some implementations, using the supervisor to manage the lifecycle of the virtual trusted platform module includes managing a retirement of the virtual trusted platform module.

In some implementations, containing the virtual trusted platform module within the secure enclave includes executing machine executable instructions to provide the virtual trusted platform module, locating the instructions in a memory container of the physical platform and managing execution of the instructions to confine access to the container via microcode of a microprocessor such that the memory container is not accessible via executed instructions residing outside of the container.

In some implementations, containing the virtual trusted platform module within the secure enclave includes executing machine executable instructions to provide the virtual trusted platform module, locating the instructions in a memory container of the physical platform and providing cryptographic protection of content moved to and from the memory container.

In some implementations, the physical platform includes a physical trusted platform module, and the technique further includes storing at least one measurement of the virtual machine in the virtual trusted platform module and storing a pointer to the physical trusted platform module in the virtual trusted platform module.

In further implementations, an apparatus includes a processor that is configured to perform any of the above-mentioned techniques.

In further implementations, at least one machine readable medium includes a plurality of instructions that in response to being executed on a computing device, cause the computing device to carry out any of the above-described techniques.

In further implementations, an apparatus includes a microprocessor and a memory. The microprocessor is adapted to create a secure enclave in the memory and protect a virtual trusted platform module for a virtual machine using the secure enclave.

In some implementations, the microprocessor is further adapted to protect a supervisor that securely manages a lifecycle of the virtual trusted platform module using the secure enclave.

In some implementations, the supervisor is adapted to perform one or more of the following: provision the virtual trusted platform module, sign an attestation identification credential for the virtual trusted platform module, regulate a migration of the virtual trusted platform module and regulate retirement of the virtual trusted platform module.

In some implementations, the microprocessor is further adapted to create at least one additional secure enclave in the memory and protect at least one additional virtual trusted platform module for at least one additional virtual machine using the additional secure enclave(s).

In some implementations, the microprocessor is further adapted to execute machine executable instructions to provide the virtual trusted platform module, confine execution of the instructions to a container of the memory and provide cryptographic protection of content moved to and from the container.

In some implementations, the microprocessor is further adapted to execute machine executable instructions to provide the virtual trusted platform module and execute microcode to confine execution of the instructions to a container of the memory such that the container is not accessible via executed instructions residing outside of the container.

In some implementations, the microprocessor is adapted to store at least one measurement of the virtual machine in the virtual trusted platform module and store a pointer to a physical trusted platform module in the virtual trusted platform module.

While a limited number of examples have been disclosed herein, those skilled in the art, having the benefit of this disclosure, will appreciate numerous modifications and variations therefrom. It is intended that the appended claims cover all such modifications and variations.

1. A method comprising:
providing a virtual trusted platform module for a virtual machine; and
containing the virtual trusted platform module within a secure enclave of a physical platform.

2. The method of claim 1, wherein providing the virtual trusted platform module comprises providing a supervisor and using the supervisor to securely manage a lifecycle of the virtual trusted platform module.

3. The method of claim 2, further comprising containing the supervisor within a secure enclave.

4. The method of claim 2, wherein using the supervisor to manage the lifecycle of the virtual trusted platform module comprises provisioning the virtual trusted platform module, the provisioning comprising assigning at least one security key to the virtual trusted platform module to identify the module.

5. The method of claim 4, wherein provisioning the virtual trusted platform module further comprises the supervisor signing an attestation identification credential for the virtual trusted platform module.

6. The method of claim 2, wherein using the supervisor to manage the lifecycle of the virtual trusted platform module comprises using the supervisor to assign the virtual trusted platform module to the virtual machine.

7. The method of claim 2, wherein using the supervisor to manage the lifecycle of the virtual trusted platform module comprises managing a migration of the virtual trusted platform module to another physical platform.

8. The method of claim 2, wherein using the supervisor to manage the lifecycle of the virtual trusted platform module comprises managing a retirement of the virtual trusted platform module.

9. The method of claim 1, wherein containing the virtual trusted platform module within the secure enclave comprises:
executing machine executable instructions to provide the virtual trusted platform module;
locating the instructions in a memory container of the physical platform; and
managing execution of the instructions to confine access to the container via microcode of a microprocessor such that the memory container is not accessible via executed instructions residing outside of the container.

10. The method of claim 1, wherein containing the virtual trusted platform module within the secure enclave comprises:
executing machine executable instructions to provide the virtual trusted platform module;
locating the instructions in a memory container of the physical platform; and
providing cryptographic protection of content moved to and from the memory container.

11. The method of claim 1, wherein the physical platform comprises a physical trusted platform module, the method further comprising:
storing at least one measurement of the virtual machine in the virtual trusted platform module; and
storing a pointer to the physical trusted platform module in the virtual trusted platform module.

12. (canceled)

13. At least one machine readable medium comprising a plurality of instructions that in response to being executed on a computing device, cause the computing device to:
provide a virtual trusted platform module for a virtual machine; and
contain the virtual trusted platform module within a secure enclave of a physical platform.

14. An apparatus comprising:
a microprocessor; and
a memory,
wherein the microprocessor is adapted to:
create a secure enclave in the memory; and
protect a virtual trusted platform module for a virtual machine using the secure enclave.

15. The apparatus of claim 14, wherein the microprocessor is further adapted to protect a supervisor that securely manages a lifecycle of the virtual trusted platform module using the secure enclave.

16. The apparatus of claim 15, wherein the supervisor is adapted to perform one or more of the following: provision the virtual trusted platform module, sign an attestation identification credential for the virtual trusted platform module, regulate a migration of the virtual trusted platform module and regulate retirement of the virtual trusted platform module.

17. The apparatus of claim 14, wherein the microprocessor is further adapted to:
create at least one additional secure enclave in the memory; and
protect at least one additional virtual trusted platform module for at least one additional virtual machine using the at least one additional secure enclave.

18. The apparatus of claim 14, wherein the microprocessor is further adapted to:
execute machine executable instructions to provide the virtual trusted platform module;
confine execution of the instructions to a container of the memory; and
provide cryptographic protection of content moved to and from the container.

19. The apparatus of claim 14, wherein the microprocessor is further adapted to:
execute machine executable instructions to provide the virtual trusted platform module; and
execute microcode to confine execution of the instructions to a container of the memory such that the container is not accessible via executed instructions residing outside of the container.

20. The least one machine readable medium of claim 13, the medium storing instructions that when executed by the computing device, cause the computing device to provide a supervisor and use the supervisor to securely manage a lifecycle of the virtual trusted platform module.
